(19) United States
(12) Patent Application Publication
(10) Pub. No.: US 2006/0093178 A1
(43) Pub. Date: May 4, 2006

(54) Eye-wear with built-in audio

(75) Inventor: Leo Chen, Hong Kong SAR (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fortech Macao Commercial Offshore Co., Ltd., Macau SAR (CN)

(21) Appl. No.: 11/248,208

(22) Filed: Oct. 13, 2005

(30) Foreign Application Priority Data
Oct. 13, 2004 (CN) 200420014256X

(51) Int. Cl. H04R 25/00

(52) U.S. Cl. 381/370; 381/312

(57) ABSTRACT

An eye-wear comprising a viewing frame, a pair of arms extending from the viewing frame, audio circuitry, a pair of ear-pieces and a battery compartment, wherein the pair of ear-pieces are respectively and detachably attached to the pair of arms and each ear-piece is connected to the audio circuitry and an arm via a flexible cord.

### FIELD OF THE INVENTION

This invention relates to eye-wear and, more particularly, to a pair of eyeglasses with built-in audio circuitry.

### BACKGROUND OF THE INVENTION

Audio players, for example, radio and/or MP3 players, are useful accessories. Portable audio players are frequently carried by people on the move, for example, during shopping, commuting or jogging. Conventional portable audio players are typically carried by a user, for example, by clipping onto clothes or wearing around the neck. A length of audio cable which extends between an audio player and a pair of earpieces is usually required in order to convert the electrical signals from an audio player to audio sounds detectable by the ears of a user. However, such a length of audio cable and the need to attach an audio player to the body of a user can be a nuisance sometimes. Eye-wear, such as, for example, sunglasses, are commonly worn by people in the move or during sport. Eye-wear with built-in audio players are known. Such audio eye-wear are, for example, described in U.S. Pat. No. 4,856,086, U.S. Pat. No. 4,882,769 and U.S. Pat. No. 6,349,001. However, conventional audio type eye-wear are not satisfactory. For example, in the audio eye-wear described in U.S. Pat. No. 4,882,769, the earpieces extend downwardly from an arm of the audio eye-wear through a rigid link. A major disadvantage of such a configuration is that the separation between an eyepiece and an arm is substantially fixed and the permanently downward dependence of an earpiece from an underside of an arm may cause discomfort, and is sometimes a nuisance to a user. On the other hand, audio eye-wear described in U.S. Pat. No. 4,856,086 comprises a pair of eyepieces freely suspended from a pair of arms. Such freely suspending earpieces are inconvenient, and sometimes a nuisance, to a user, especially during movements.

### OBJECT OF THE INVENTION

Accordingly, it is an object of this invention to provide an audio eye-wear which mitigates disadvantages of conventional audio eye-wear. At a minimum, it is an object of this invention to provide the public with a useful choice of audio eye-wear.

### SUMMARY OF THE INVENTION

Broadly speaking, the present invention has described an eye-wear comprising a viewing frame, a pair of arms extending from the viewing frame, audio circuitry, a pair of ear-pieces and a battery compartment, wherein the pair of ear-pieces are respectively and detachably attached to the pair of arms and each ear-piece is connected to the audio circuitry and an arm via a flexible cord.

Preferably, each of the flexible cord comprises a resiliently extendible portion intermediate an ear-piece and an arm whereby distance between an ear-piece and an arm can be varied.

Preferably, co-operative retention means is provided on an ear-piece and a corresponding arm for detachably attaching an ear-piece to an arm when the ear-phone is not in use.

Preferably, the retention means comprises a plug and socket pair, the plug and socket being respectively formed on an ear-piece and an arm.

Preferably, the co-operative retention means comprises a bayonet-type connector, the bayonet-type connector comprises a tongue which protrudes from an arm and a tongue receptacle on the ear-piece, the tongue extends towards a free end of an arm with its free end extending towards a free end of the arm.

Preferably, the flexible cord protrudes from an underside of the ear-phone.

Preferably, the audio circuitry is enclosed within an audio circuitry compartment, the audio circuitry compartment and the battery compartment being symmetrically disposed about a central longitudinal axis which divides the viewing frame into two lateral halves.

Preferably, the battery compartment is disposed whereby the weight of the audio circuitry and the audio circuitry compartment is counter-balanced by the weight of said battery and said battery compartment.

Preferably, the battery compartment and the audio circuitry compartment are disposed on separate arms, wherein each of said battery and said audio circuitry compartment is on an arm and intermediate the viewing frame and ear-contact portion of the arm.

Preferably, wherein the audio circuitry comprises MP3 play-back circuitry.

Preferably, the audio circuitry comprises battery charging circuitry.

Preferably, the viewing frame includes a pair of sunglasses.

Preferably, the audio circuitry comprises a radio receiver.

Preferably, control buttons are disposed on an upper side of an arm.

Preferably, the eye-wear further comprising an audio circuitry compartment for receiving audio circuitry, the battery compartment and the audio circuitry compartment are located at the temple portion of the eye-wear.

Preferably, the exterior shape, configuration and dimensions of the battery compartment and the audio circuitry compartments are the same.

Preferably, the eye-wear further comprising a remote control receiver for receiving wireless control signal for operating the audio circuitry.

Preferably, the eye-wear further comprising a radio receiver for receiving wireless signals to the audio circuitry, wherein an antennae is embedded in the viewing frame.

Preferably, the eye-wear further comprising a radio receiver for receiving wireless signals to the audio circuitry, wherein an antennae is embedded in the arms.

In another preferred embodiment, there is provided an eye-wear comprising a viewing frame, a pair of arms extending from the viewing frame, audio circuitry, a pair of ear-pieces and a battery compartment, wherein the audio circuitry is enclosed within an audio circuitry compartment, the audio circuitry compartment and the battery compartment being symmetrically disposed about a central longitudinal axis which divides the viewing frame into two lateral halves, wherein each of said battery and said audio circuitry compartment is on an arm and intermediate the viewing frame and ear-contact portion of the arm.

### BRIEF DESCRIPTION OF THE DRAWINGS

Preferred embodiments of the present invention will be explained in further detail below by way of examples and with reference to the accompanying drawings, in which:

FIG. 1 is a front perspective view of an audio eye-wear showing a first preferred embodiment of this invention,

FIG. 2 is a rear perspective view of the eye-wear of FIG. 1 with a pair of earpieces attached to the eye-wear,

FIG. 3A is a side view of the eye-wear of FIG. 1,

FIG. 3A1 is a side view of FIG. 3A with the battery compartment cover removed,

FIG. 3B is a side view of the eye-wear of FIG. 1 from another side,

FIG. 3B1 is an enlarged view of the right arm (140),

FIG. 4 is a top plan view of the eye-wear with ear-pieces un-hooked,

FIGS. 5 is the eye-wear of FIG. 4 with one ear-piece hooked,

FIG. 6A is an exemplary block diagram of a remote controller for use with a third preferred embodiment of this invention,

FIG. 6B is a block diagram showing circuitry blocks in a third preferred embodiment of this invention, and

FIG. 7 is a schematic illustration showing a third preferred embodiment of this invention in end use.

### DETAILED DESCRIPTION OF THE PREFERRED EMBODIMENTS

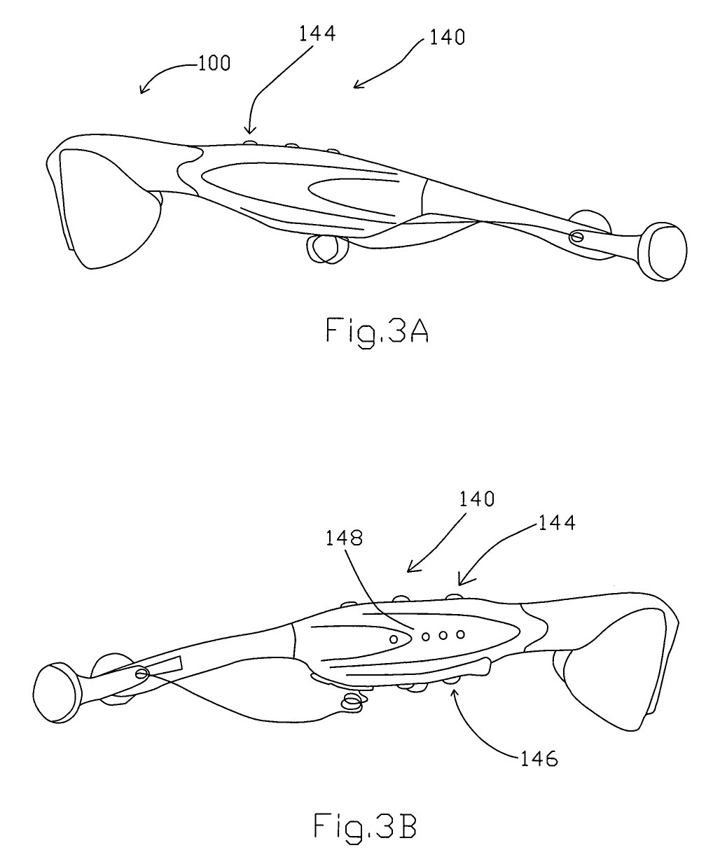

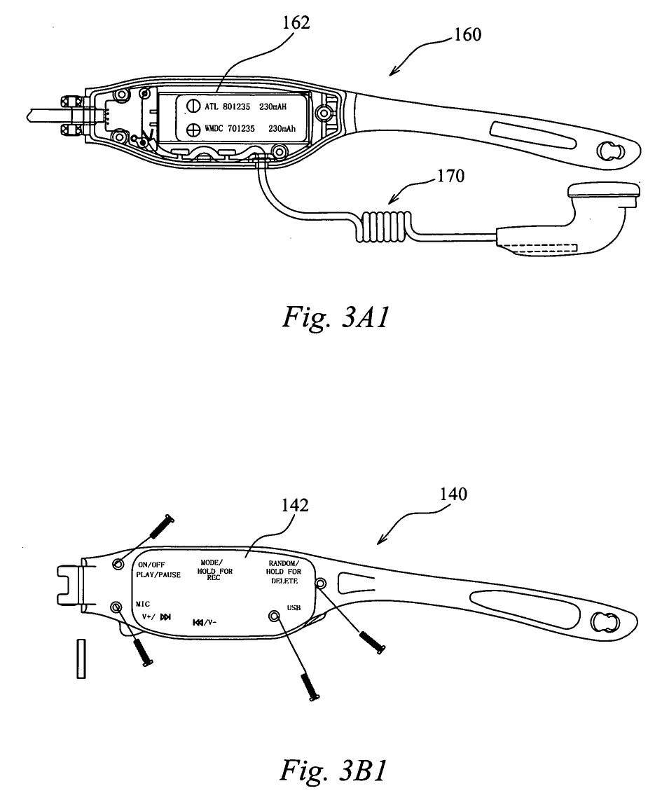

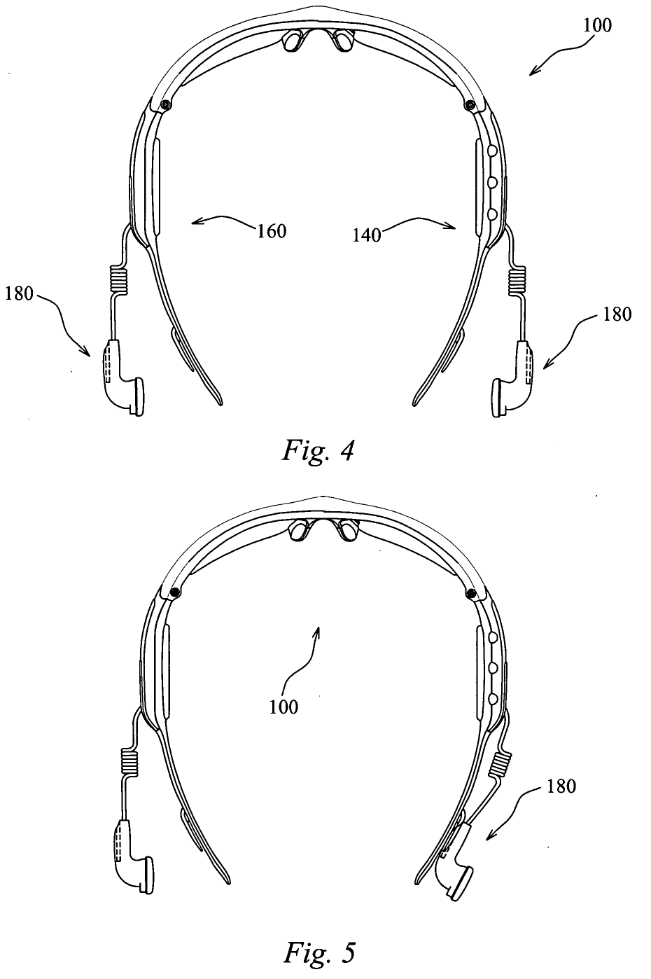

Referring firstly to FIGS. 1 to 5, there is shown an audio eye-wear 100 as a first preferred embodiment of this invention. The audio eye-wear 100 comprises eye-wear in the form of a pair of sunglasses with built-in audio circuitry. The pair of sunglasses comprises a viewing frame 120 and a pair of arms 140, 160 respectively hinged to the viewing frame 120 so that the pair of arms 140, 160 can be collapsed for storage. The viewing frame 120 comprises a lateral bridge 122 which spans across the forehead of a user when in use. A pair of nose supports extends downwardly from the lateral bridge so that the viewing frame can be supported on the nose of a user. A pair of lenses, for example, sun lenses (glass or plastic lens), is attached to the viewing frame and each lens is attached to the viewing frame intermediate a nose support and the lateral bridge. The lateral bridge and the pair of nose supports are integrally moulded from durable plastics. The pair of arms 140, 160 provides a support structure so that the viewing frame can be substantially fixed around the forehead of a user by attaching the pair of arms to the ears of a user. Each of the arms 140, 160 is shaped and dimensioned so that the free end of the arm extends beyond the upper arch of an ear of a user.

An audio circuitry compartment 142 is formed on the right arm 160 for containing audio circuitry. An exemplary audio circuitry comprises MP3 chip set for playing pre-recorded music. The MP3 chip set comprises a MP3 control chip, for example, STMP 3505, which is connected with a memory chip and a USB socket. The memory chip can be a NAND flash for storage of pre-recorded music or other audio information. Audio output from the MP3 chip set is delivered to the earpieces via a pair of signal cords. A plurality of control buttons are distributed on the top and bottom sides of the arms. For example, “random delete”, “REC mode”, “ON/OFF” buttons 144 are disposed on the top side of the end. Volume control buttons 146 are disposed on the underside of the arms. A plurality of operating conditions indicators 148, such as “charge”, “REC”, “MP3” and “Power/USB” indicators are disposed on the outer side of the right arm 160.

To accommodate the audio playing circuitry and the various control buttons and indicators, the audio circuitry compartment 142 comprises a base portion and a cover lid. The base portion comprises a cavity which is integrally moulded with the right arm 160 at the time of formation of the right arm. The cover lid is attached to the base portion after the circuitry and the relevant buttons have been put in place. In addition, a USB socket is formed at the bottom side of the compartment to allow loading or un-loading of pre-recorded audio files. Audio signal output from the MP3 audio playing circuitry is delivered by a flexible signal cord 170 to an earpiece 180. The flexible signal cord 170 exits from the audio circuitry compartment at its bottom side. Optionally, a radio tuner can be incorporated into the audio circuitry to provide additional choice to a user.

A battery compartment 162 is integrally formed on the left arm 160. The battery compartment 162 provides a cavity and necessary contacts for a battery or batteries to supply operating power to the audio circuitry. The battery compartment 162 and the audio circuitry compartment 142 are connected by wiring which is embedded in the viewing frame. More particularly, the wiring is embedded in the lateral bridge 122 and the arms. The battery compartment 162 and the audio compartment 142 are disposed at approximately the same distance away from the viewing frame so that they are substantially symmetrically disposed about an imaginary longitudinal axis which divides the viewing frame into two equal halves. More particularly, the imaginary axis extends orthogonally from the viewing frame and is substantially parallel to the pair of arms 140, 160 when they are in the fully expanded mode. The substantially symmetrical disposition facilitates counter-balancing of the weight of the audio circuitry by the weight of the battery. To further enhance symmetry about the imaginary dividing axis, the battery compartment and the audio circuitry compartment are shaped and dimensioned so that they are substantially identical when viewed from the outside.

The audio eye-wear 100 comprises a pair of eyepieces for converting electrical signals of the audio-circuitry into audible signals. Each eyepiece 180 comprises an ear-phone of the ear-plug type. An earpiece is connected to the audio circuitry via a flexible signal cord. The signal cord exits at near the middle portion of an arm 140, 160 so that the earpiece is freely suspending from the arms. The portion of the flexible cord which extends between the arm and the ear-phone comprises a resiliently extendable portion so that the effective length of the exposed signal cord is variable to cater for users having different facial characteristics. The extendibility of the flexible signal cord is conferred by a length of helically coiled flexible cord which provides the necessary degree of resilience and extension.

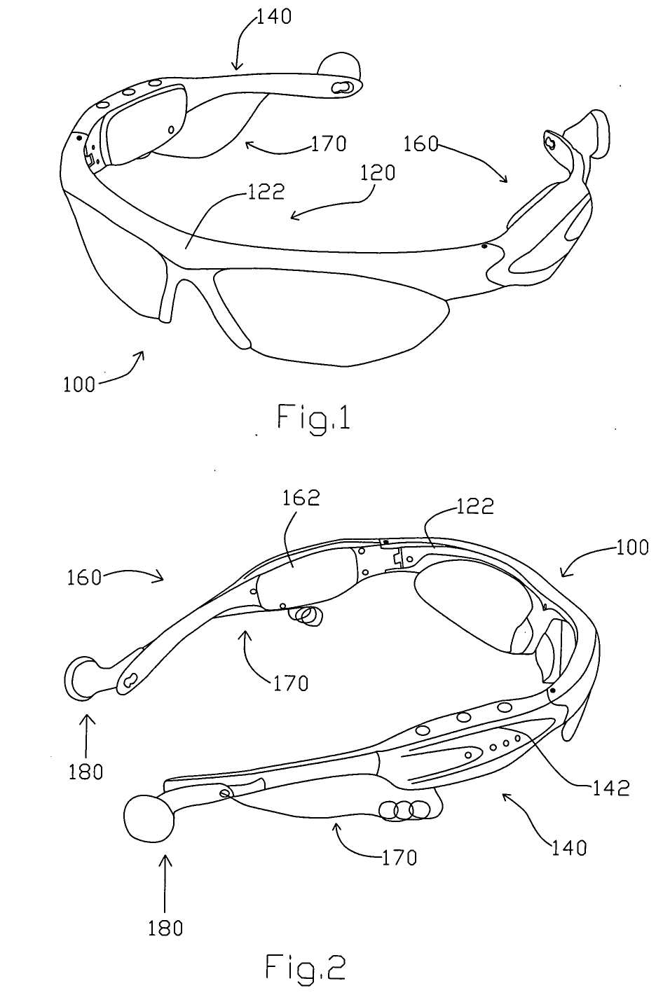

To mitigate the inconvenience and annoyance due to a freely suspended earpiece, co-operative retention means is provided. The co-operative retention means comprises fastening means which are distributed respectively on the eye-wear and the earpiece. As shown in FIG. 2 a pair of plug and socket fastener or a bayonet-type fastener is provided. The bayonet-type connector comprises an axial tongue which protrudes from the outside of an arm and extends axially rear wards towards the free end of the arms. The housing of the earpiece comprises an elongated cavity or bore for receiving the protruding tongue. When the earpiece is not required, the earpiece can be attached to the arm by inserting the bore of the earpiece towards the protruding tongue. The bore is formed on an elongated housing with the audio speaker off set from the axis of the bore so that when the bore is coupled onto the protruding tongue, the speaker faces outwardly. The protruding tongue is preferable integrally moulded with the arm and is made spring resilient. When the ear-phone is fully coupled with the protruding tongue, the protruding tongue is slightly forced away from the arm. The resulting resilient force due to the slight deformation of the protruding tongue away from the arm will result in compressive holding of the ear-phone housing by the protruding tongue. Similarly, the pair of protruding tongues are formed at substantially the same longitudinal distance from the viewing frame for enhanced symmetry. Each of the battery compartment and the audio circuitry compartment is disposed at the temple portion of the arms. This disposition is beneficial because more useful space is available at this portion of the arm and additional space for storing parts and components can be obtained without causing significant discomfort or inconvenience to a user. Hence, it will be beneficial that the battery and audio circuitry compartments are disposed near the front half of the arms, and, more particularly, at the temple portions.

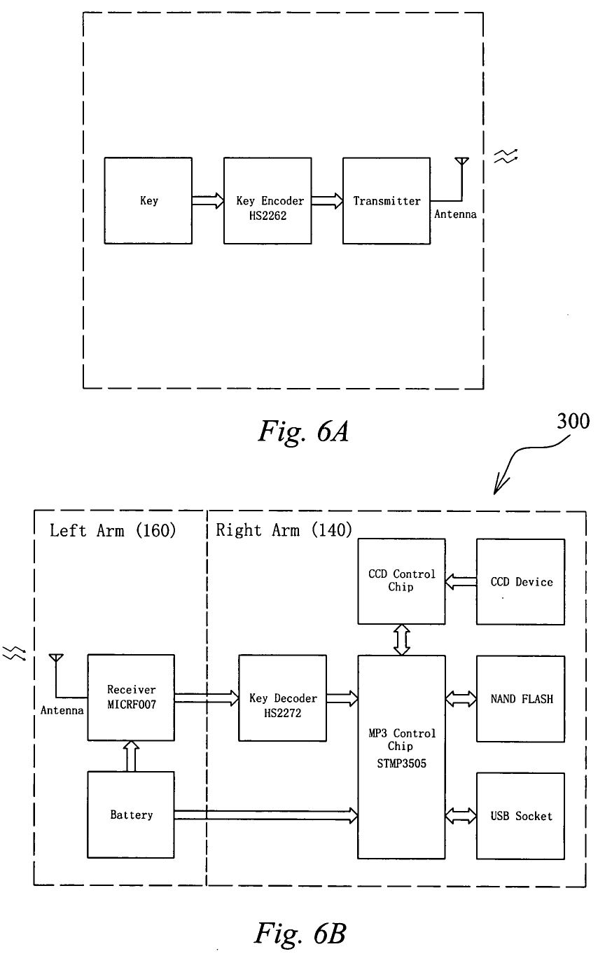

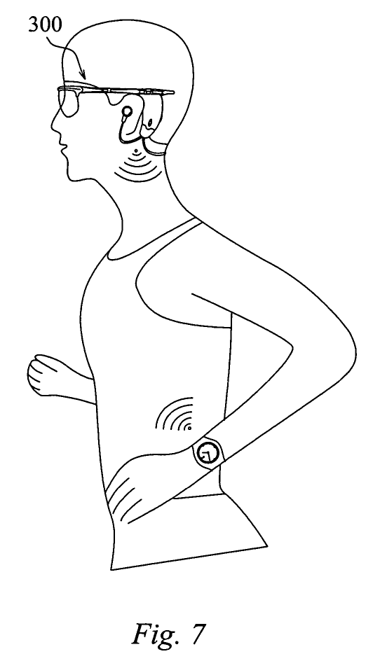

In a second preferred embodiment of this invention as shown in FIGS. 6A, 6B and 7, the eye-wear further comprises a radio-control receiver so that the control of the audio circuitry can be effected by a remote-control means, such as a remote-control watch as shown in FIG. 7. The remote controller comprises a controller as shown in FIG. 6A which comprises a key, a key encoder (HS2262), a transmitter and an antenna. The remote-control circuitry can be incorporated as part of a watch, for example, a watch with a USB port plusr data storage capability so that pre-recorded music or other digital audio information can be loaded to the audio circuitry in the eye-wear by wireless means, for example, by radio frequency transmission or infrared transmission. An exemplary circuitry of the third preferred embodiment of an eye-wear is shown in FIG. 6B. In this arrangement, a wireless receiver, for example, MICRF 007, and a battery are disposed in the battery compartment on the left arm 160. The audio circuitry, including the MP3 control chip, NAND flash, USB socket, key decoder (HS2272) and optionally, CCD chip device and CCD control chip are disposed in the audio circuitry compartment of the right arm 140. As shown in FIG. 7, a person on the move can wear the eye-wear with the earpieces plugged in the ear with music playing during movement. To provide more convenient control, the audio circuitry in the eye-wear can be controlled with a wrist-worn remote controller. Of course, other portable remote-controller can be used for the control of the audio circuitry.

In the above description, parts which are common to the various embodiments are represented with the same numerals wherever the context permits.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to a pair of sunglasses, it should be appreciated that the invention can apply, whether with or without modification, to other eye-wear without loss of generality.

1. An eye-wear comprising a viewing frame, a pair of arms extending from the viewing frame, audio circuitry, a pair of ear-pieces and a battery compartment, wherein the pair of ear-pieces are respectively and detachably attached to the pair of arms and each ear-piece is connected to the audio circuitry and an arm via a flexible cord.

2. An eye-wear according to claim 1, wherein each of the flexible cord comprises a resiliently extendible portion intermediate an ear-piece and an arm whereby distance between an ear-piece and an arm can be varied.

3. An eye wear according to claim 1, wherein co-operative retention means is provided on an ear-piece and a corresponding arm for detachably attaching an ear-piece to an arm when the ear-phone is not in use.

4. An eye-wear according to claim 3, wherein the retention means comprises a plug and socket pair, the plug and socket being respectively formed on an ear-piece and an arm.

5. An eye-wear according to claim 3, wherein the co-operative retention means comprises a bayonet-type connector, the bayonet-type connector comprises a tongue which protrudes from an arm and a tongue receptacle on the ear-piece, the tongue extends towards a free end of an arm with its free end extending towards a free end of the arm.

6. An eye-wear according to claim 1, wherein the flexible cord protrudes from an underside of the ear-phone.

7. An eye-wear according to claim 1, wherein the audio circuitry is enclosed within an audio circuitry compartment, the audio circuitry compartment and the battery compartment being symmetrically disposed about a central longitudinal axis which divides the viewing frame into two lateral halves.

8. An eye-wear according to claim 1, wherein the battery compartment is disposed whereby the weight of the audio circuitry and the audio circuitry compartment is counter-balanced by the weight of said battery and said battery compartment.

9. An eye-wear according to claim 8, wherein the battery compartment and the audio circuitry compartment are disposed on separate arms, wherein each of said battery and said audio circuitry compartment is on an arm and intermediate the viewing frame and ear-contact portion of the arm.

10. An eye-wear according to claim 8, wherein the audio circuitry comprises MP3 play-back circuitry.

11. An eye-wear according to claim 8, wherein the audio circuitry comprises battery charging circuitry.

12. An eye-wear according to claim 8, wherein the viewing frame includes a pair of sunglasses.

13. An eye-wear according to claim 8, wherein the audio circuitry comprises a radio receiver.

14. An eye-wear according to claim 8, wherein control buttons are disposed on an upper side of an arm.

15. An eye-wear according to claim 1, further comprising an audio circuitry compartment for receiving audio circuitry, the battery compartment and the audio circuitry compartment are located at the temple portion of the eye-wear.

16. An eye-wear according to claim 15, wherein the exterior shape, configuration and dimensions of the battery compartment and the audio circuitry compartments are the same.

17. An eye-wear according to claim 1, further comprising a remote control receiver for receiving wireless control signal for operating the audio circuitry.

18. An eye-wear according to claim 1, further comprising a radio receiver for receiving wireless signals to the audio circuitry, wherein an antennae is embedded in the viewing frame.

19. An eye-wear according to claim 18, further comprising a radio receiver for receiving wireless signals to the audio circuitry, wherein an antennae is embedded in the arms.

20. An eye-wear comprising a viewing frame, a pair of arms extending from the viewing frame, audio circuitry, a pair of ear-pieces and a battery compartment, wherein the audio circuitry is enclosed within an audio circuitry compartment, the audio circuitry compartment and the battery compartment being symmetrically disposed about a central longitudinal axis which divides the viewing frame into two lateral halves, wherein each of said battery and said audio circuitry compartment is on an arm and intermediate the viewing frame and ear-contact portion of the arm.
